(19) United States
(12) Patent Application Publication
(10) Pub. No.: US 2013/0084646 A1
(43) Pub. Date: Apr. 4, 2013

(54) QUANTIFYING ELEMENTAL SULFUR IN LIQUID HYDROCARBONS

(71) Applicants: John B. Green, Bartlesville, OK (US); Laura L. Young, Bartlesville, OK (US)

(72) Inventors: John B. Green, Bartlesville, OK (US); Laura L. Young, Bartlesville, OK (US)

(73) Assignee: PHILLIPS 66 COMPANY, Houston, TX (US)

(21) Appl. No.: 13/626,495

(22) Filed: Sep. 25, 2012

Related U.S. Application Data
(60) Provisional application No. 61/541,562, filed on Sep. 30, 2011.

(51) Int. Cl. G01N 27/62

(52) U.S. Cl. 436/173

(57) ABSTRACT

The present disclosure relates to a novel GC/MS/MS method for quantifying levels of elemental sulfur in hydrocarbons, including crude petroleum, petroleum products, and liquefied hydrocarbon gases.

### CROSS-REFERENCE TO RELATED APPLICATIONS

This application is a Non-Provisional application which claims the benefit of and priority to U.S. Provisional Application Ser. No. 61/541,562 filed Sep. 30, 2011, entitled “Quantifying Elemental Sulfur in Liquid Hydrocarbons,” which is hereby incorporated by reference.

### STATEMENT REGARDING FEDERALLY SPONSORED RESEARCH OR DEVELOPMENT

None.

### FIELD OF THE INVENTION

The present disclosure relates generally to methods for quantifying levels of elemental sulfur in hydrocarbons. More specifically, the present disclosure relates to methods for quantifying levels of elemental sulfur in crude petroleum and other liquid hydrocarbons.

### BACKGROUND

Polarography has been the technique traditionally used since the 1950's to measure elemental sulfur (S8) levels in petroleum and petroleum products. However, applying polarography to analysis of petroleum is challenging in that a suitable electrolyte solution must be found that is was compatible with petroleum, will dissolve S8, and conduct electric current adequately. Over time, the use of polarographic methods for measurement of S8 is being phased-out because these methods utilize potentially hazardous dropping mercury electrodes and require expensive ongoing maintenance of the specialized equipment required for these methods. Thus, alternative methods are needed for accurately quantifying S8 at low levels.

Existing methods based on MS, or even GS/MS for measurement of S8 have been published. However, these methods are limited in that they only work effectively with more volatile samples, such as naphtha or gasoline. GC/MS is prone to significant interference in analysis of S8 in crude oil or heavy distillates/resides. The same is true for GC methods based on sulfur selective detectors. Interference from dibenzothiophene homologs and other sulfur types present in crude oil effectively mask a small S8 peak in the group of sulfur species normally present in crudes or heavy petroleum fractions.

Methods based upon direct probe sample introduction (in combination with MS/MS) suffer from numerous disadvantages, including sample carryover, rapid degradation of instrument performance (due to gunk build-up on ion volume, source lenses and mass separation components), lack of automation, poor reproducibility (due to inconsistent evolution of sample components off the probe), and poor sensitivity.

The methods described in the current disclosure enable the accurate and reproducible measurement of S8 in a broad spectrum of hydrocarbon samples, including heavy crude oils, heavy distillates, and residuum fractions, while minimizing build up of non-volatile materials that would necessitate frequent equipment maintenance.

### BRIEF SUMMARY OF THE DISCLOSURE

Novel methods are described herein for the determination of elemental sulfur (S8) in crude oil and petroleum products, including pressurized liquids such as propane and propylene. Certain embodiments of the invention comprise the steps of: a) providing a hydrocarbon sample, and subjecting the sample to a liquid chromatographic separation to produce a purified sample; b) separating the purified sample on a gas chromatography column to produce a separated purified sample; c) passing the separated purified sample into a mass spectrometer, wherein molecular ions are separated in a first sector, collided with Ar gas in a second sector, and the resulting fragments isolated and detected in a third sector; and d) determining the concentration of elemental sulfur present in the sample of step a) utilizing the data obtained in step c).

In certain embodiments, the process further comprises a step for adding a silylating agent to the purified sample just prior to step b) to improve the accuracy of the calculation of step d). In certain embodiments, the process further comprises adding an internal standard to the purified sample just prior to step b), to improve the accuracy and precision of step d).

### BRIEF DESCRIPTION OF THE DRAWINGS

A more complete understanding of the present invention and benefits thereof may be acquired by referring to the follow description taken in conjunction with the accompanying drawings in which:

FIG. 1 depicts a GC/MS/MS chromatogram for a response factor (RF) internal standard.

FIG. 2 depicts a GC/MS/MS chromatogram for a gasoline sample that was found to contain 0.49 ppm S8 using the methods described herein.

The invention is susceptible to various modifications and alternative forms, specific embodiments thereof are shown by way of example in the drawings. The drawings may not be to scale. It should be understood that the drawings and their accompanying detailed descriptions are not intended to limit the scope of the invention to the particular form disclosed, but rather, the intention is to cover all modifications, equivalents and alternatives falling within the spirit and scope of the present invention as defined by the appended claims.

### DETAILED DESCRIPTION

Methods are provided herein for the determination of elemental sulfur (S8) in crude oil, heavy distillates and residuum fractions, and petroleum products including pressurized hydrocarbon liquids such as propane and propylene. For crude oil, heavy distillates and residuum fractions, the methods generally include a preliminary liquid chromatographic (LC) separation on silica. This step removes constituents from the sample having a high boiling point (such as, for example, asphaltenes), thereby protecting the instrument from a build up of non-volatile materials that would necessitate frequent clean-up and maintenance. The LC separation step also lowers background signal, thus, enhancing sensitivity of the process for measuring low levels of S8. Pressurized liquids are vented into toluene, and the resulting solution analyzed by gas chromatography/mass spectrometry/mass spectrometry (GC/MS/MS) methodology. The mass spectrometer is operated in the parent MS/MS mode where the molecular ion is separated in the first sector, collided with Ar gas in the second sector, and the resulting fragments (“daughter ions”) isolated and detected in the third sector of the instrument. The multiple mass separations in addition to the preliminary capillary GC separation afford a high degree of selectivity for S8 at ppm and sub-ppm levels. An internal standard may be added to the sample to assist in measuring the level of S8 in the sample. Optionally, a silylating agent may be co-injected into the GC/MS/MS instrument with the sample to improve peak shape and peak area reproducibility of the S8 analyte.

In certain embodiments, a preliminary LC separation of S8 from a liquid hydrocarbon sample with a boiling point greater than about 650° F. (such as, for example, crude oil, heavy distillate, and residuum fractions) is accomplished by obtaining about a 0.5 g sample of the liquid hydrocarbon, and adding 0.5 g of toluene to dissolve the sample and act as a diluent to enable the hydrocarbon sample to be transferred to the silica column.

In certain embodiments, the glass columns used for preliminary liquid chromatographic (LC) separation of S8 on silica are typically 30×1.5 (id) cm and are fitted with a Teflon stopcock for flow control. A plug of glass wool is inserted at the bottom of a clean glass column and it is filled with a bed length of activated silica gel. Silica gel is nominal 100-200 mesh particle size and 60 A pore size. It is activated at 120° C. overnight before use, and stored in an airtight container. Ultra high purity hexane can optionally be added to the column to prevent excessive air exposure of the silica and to precondition the packed column. Sample is then transferred to the column using a Pasteur pipette, followed by addition of a total of about 1.5 mL of hexane to complete transfer of the sample into the column. Additional hexane may be added to maintain the flow rate of the sample. The first 4 to 4.5 mL of effluent from the column is discarded, and an additional volume collected that contains the sample.

An internal standard may be added at an appropriate level to the eluted sample. The internal standard is preferably not a compound normally found in crude oil (such as, for example 2-bromobiphenyl), and many suitable internal standards are commercially available. Standards are typically prepared in toluene containing 10 wt % of an elemental sulfur-free oil that boils in the range of approximately 650° F.-1000° F. The presence of this oil reduces variation in peak areas due to GC injector discrimination effects. The response factor standard typically contains levels of S8 and 2-bromobiphenyl near 40 and 0.5 ppm, respectively, as their relative response (S8/2BrB) is near 0.02. The internal standard solution typically contains about 400 ppm 2-bromobiphenyl (0.346 ug 2BrB/uL). After addition of the internal standard, the sample is mixed, and a suitable amount (e.g., an autosampler vial) of the contents are analyzed for S8 content.

Light hydrocarbon liquids (e.g., gasoline, kerosene, diesel, ethanol) can normally be analyzed using the methods described herein with no need for an LC separation step (as described above). Optionally, one or two drops of a heavy, sulfur-free oil (such as, for example, mineral oil) may be added to these light liquids to improve the reproducibility of the analysis. Samples of pressurized hydrocarbon liquids (such as, for example, liquid propane or liquid propylene) are vented into a 100 mL graduated cylinder containing about 3 mL toluene. After the bulk of the sample has evaporated, a minimal amount of toluene is used to transfer the remaining residue to a small vial. One or two drops of mineral oil and an appropriate amount of an internal standard are added. The sample amount is determined by the difference in the weight of the full versus the empty sample bomb.

In certain embodiments, hot natural gas samples are taken in gas bombs containing a premeasured amount of toluene (determined as the difference in weight between the empty and toluene-spiked bomb). The elemental sulfur present in the sample condenses inside the bomb as it cools and is subsequently dissolved into the toluene. The natural gas is vented from the bomb, and the liquid toluene removed and mixed with an appropriate amount of an internal standard. The sample amount is calculated from the difference between the weights of the full vs. empty sample bomb, minus the original weight of toluene added to the bomb.

The sample obtained can be analyzed to determine S8 levels by GC/MS/MS. The mass spectrometer utilized preferably has MS/MS capability and electron impact ionization external to mass separation, such as, for example, Thermo-Finnigan TSQ 7000 triple quad mass spectrometer (Thermo Scientific, San Jose, Calif.). Such analytic instruments are commercially available from a number of vendors. GC/MS/MS conditions required to perform the methods described herein may vary somewhat depending upon the instrument utilized, but such optimization is easily within the reach of those having skill in the art.

In certain embodiments, a silylating agent was co-injected with the sample containing S8. The formation of a silyl ether from a hydroxyl function may provide a volatile derivative for GC and GC-MS. Many different organosilyl protecting groups are known, providing a wide spectrum of chemical stability and steric demand. A number of different reagents may be available for the introduction of a particular silyl group, allowing silylation under a variety of conditions. Silylating agents comprising a trimethylsilil group may be preferred, such as, for example, N,O-bis-(trimethylsilyl)-trifluoroacetamide (BSTFA). However other silylating agents may also be used, such as, for example, those comprising a dimethyl silyl, tert-Butyldimethylsilyl, Thexyldimethylsilyl, tert-Butyldiphenylsilyl, Triethylsilyl, Triisopropylsilyl, tert-Butoxydiphenylsilyl, Dimethylphenylsilyl and 3,5-Bis(trifluoromethyl)phenyldimethylsilyl Diphenylmethylsilyl, (Chloromethyl)dimethylsilyl, Pentafluorophenyldimethylsilyl, Allyldimethylsilyl, Triphenylsilyl, Dimethylsilylene, Diethylsilylene, Di-tert-butylsilylene, Diphenylsilylene, Methylphenylsilylene, 1,3-(1,1,3,3-Tetraisopropyldisiloxanylidene) and 1,4-(1,1,4,4-Tetramethyldisilylethylidene) functional groups. Such silylating agents are commercially available from a variety of vendors worldwide.

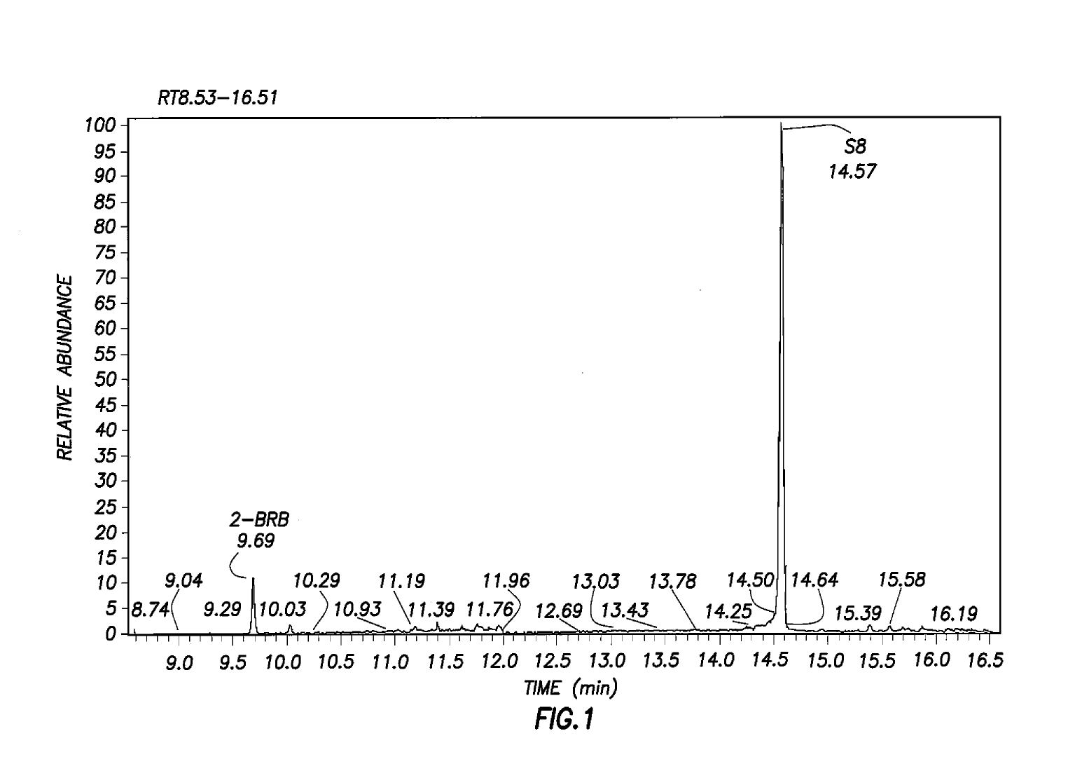

The methods of the current disclosure include interpreting the data obtained by the methods described herein. FIG. 1 shows a GC/MS/MS chromatogram for a response factor (RF) internal standard, where the sample contained 0.112 ppm of 2-Bromobiphenyl (2BrB) and 45.5 ppm S8. For this sample, the calculated RF was 0.0276. The RF for S8 relative to the internal standard 2-bromobiphenyl (2BrB) was calculated from the ratio of peak areas (A) and concentrations (ppm) of these two compounds by the formula:

RF(S8)=A(S8)/A(2BrB)×ppm(2BrB)/ppm(S8)

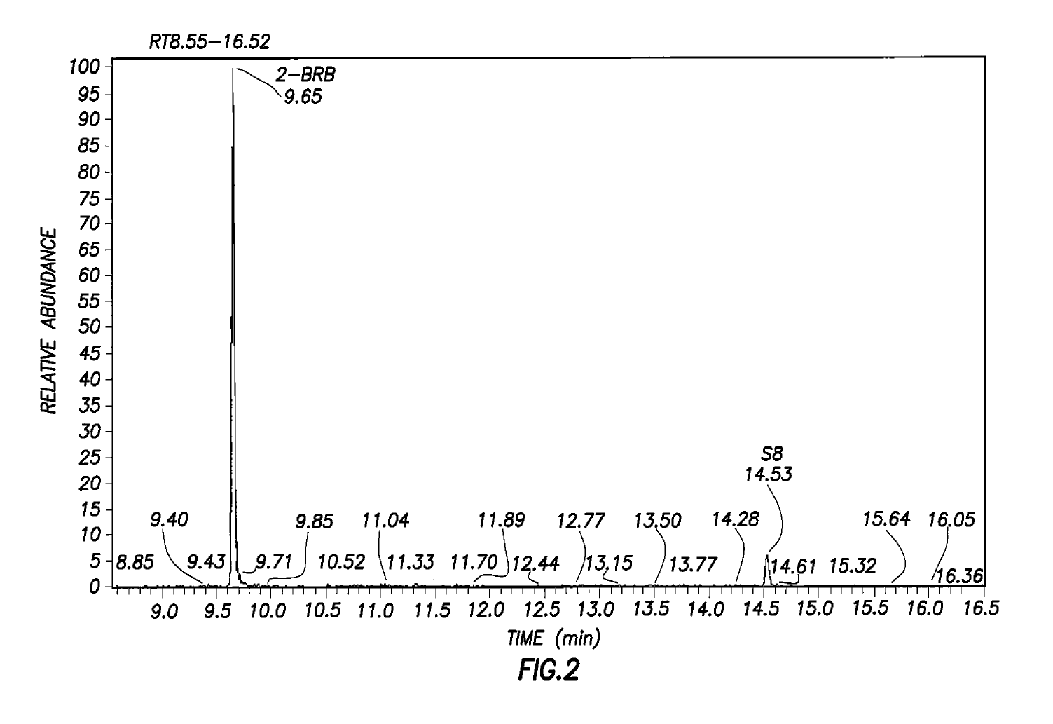

FIG. 2 depicts results obtained utilizing an embodiment of the methods described herein. FIG. 2 depicts a GC/MS/MS chromatogram obtained using the methods described herein. The amount of S8 in ppm (wt) is calculated from the area (A) ratio of S8 to 2BrB internal standard, the amount of internal standard added (ug), the sample wt in grams (g smpl), and RF as calculated above. The amount of internal standard added is the product of the volume added (uL) multiplied by the concentration of the internal standard solution in ug/uL (ug/uL=g2BrB/(g toluene+g 2BrB)×0.865 (density of toluene)×1000). In this instance, 0.347 ug of 2-bromobiphenyl internal standard was added to 2g of gasoline obtained from ConocoPhillips' Wood River Refinery, and the gasoline was determined to contain 0.49 ppm of S8 using the formula:

S8 ppm (wt)=A(S8)/A(2BrB)×ug(2BrB)/g smpl×1/RF

The following examples are intended to be illustrative of a specific embodiment of the present invention in order to teach one of ordinary skill in the art how to make and use the invention, and should not be interpreted as limiting or defining the scope of the methods disclosed herein.

### EXAMPLE 1

A Thermo-Finnigan TSQ 7000 triple quad mass spectrometer (purchased from Thermo Scientific, San Jose, Calif.) was fitted with a split/splitless injector held at 320 C. The injector was fitted with a 2mm splitless type liner which can comfortably accept liquid injection volumes up to 1.0 uL. Normally, 0.9 uL of standards/samples plus 0.1 uL silylating agent, N,O-bis-(trimethylsilyl)-trifluoroacetamide (BSTFA), were injected splitless with venting after 0.5 min. The GC temperature program used was: 90 C [hold 1 min], 10 C/min ramp to 300 C [hold 1 min]. The column was a 30m×0.25mm×0.25um film thickness 5% phenyl/95% methyl silicone type (e.g., J&W DB-5). Helium carrier gas pressure was held constant at 17 psig. A 1 m length of deactivated fused silica tubing was used to carry the column effluent into the mass spectrometer source. This interface line was held at 290 C; the MS source temperature was 180 C.

The mass spectrometer filament was turned off for the first 8.5 min of the GC program while the solvent and light petroleum-derived components were eluted. It was activated (70 ev, 400 uA) from 8.5 to 16.5 min and then turned off for the balance of the GC run while the heaviest components eluted. Argon was used as the collision gas at 1.5 mTorr pressure in the second quadrupole (Q2). The Q2 collision offset voltage was 15 V and the MS/MS correction factor was set to zero. For detection of the internal standard (2-bromobiphenyl), the first quadrupole (Q1) was scanned from m/z 231-234.4 and the third (Q3) was set at m/z 152. For detection of S8, Q1 was scanned from m/z 255-257 and Q3 was set at m/z 159.6. The transition between these two sets of MS/MS conditions occurred between the elution times of the two peaks (12 min).

### EXAMPLE 2

Tables I shows representative results obtained with the methods described herein for S8 levels in various samples of crude oil. The primary purpose for measuring S8 in crude oils is for predicting the corrosive potential of the crude oil on distillation towers. Typically, S8 is present in most crudes at the low ppm level; but, as mentioned above, it can be high enough to be expressed in percent by weight.

TABLE I
GC/MS/MS Results for Selected Crude oils (ppm wt)

| AB no. | Crude Name | S8 level |
|---|---|---|
| 296320 | WCS (Western Canada Select) | 12 |
| 296321 | LVGO (from Santa Maria refinery) | <2 |
| 296322 | Dahlia | <2 |
| 296323 | Azeri | <2 |
| 296324 | Gulfaks | 3 |
| 296325 | Merey | <2 |
| 296326 | Mondo | <2 |
| 296327 | EO6 | <2 |
| 296328 | Merlim | <2 |
| 303877 | Alliance refinery blend | <1 |
| 296320 | spiked w/183 ppm S8 | 190 |
| 296321 | spiked w/ 193 ppm S8 | 173 |

### EXAMPLE 3

Table II shows representative results obtained with the methods described herein for S8 levels in various samples of gasoline obtained from Wood River Refinery owned by ConocoPhillips Co. (Table II) and propylene samples obtained from Borger Refinery owned by ConocoPhillips Co. (Table III).

Typically, the reason for measuring S8 in gasoline and propylene samples is to determine whether S8 levels in the sample contribute to the sample failing a specification test measuring corrosivity. For example, the first three gasoline samples in Table II failed a silver corrosion test, while the fourth one passed. The levels of S8, as measured by the methods disclosed herein, confirmed that high S8 levels likely contributed to the excessive corrosivity of the first three gasoline samples. Similarly, the levels of S8 in propylene samples (shown in Table III) were determined by the methods disclosed herein, and tracked results from copper corrosion testing reasonably well.

TABLE II
GC/MS/MS Results for Gasolines (ppm wt)

| AB no. | WR no. | Description | S8 |
|---|---|---|---|
| 304050 | 442961 | Gasoline | 0.49 |
| 304822 | 4442961 | CMP Mixed Gasoline | 0.65 |
| | | Components A-54 | |
| 304823 | 4463223 | CMP Rundown to Mixed | 0.73 |
| | | Gasoline Components | |
| 304824 | 4465568 | CMP Rundown to Mixed | 0.07 |
| | | Gasoline Components | |

TABLE III
GC/MS/MS Results for Borger Propylene (ppm wt)

| AB no. | Borger no | Sample description | S8 |
|---|---|---|---|
| 303125 | 4419437 | 16640 Col. 36 feed | 0.003 |
| 303126 | 4419451 | 684006 Cavern 6 inlet | 0.004 |
| 303127 | 4419431 | 016605 Merox feed | <0.002 |
| 303128 | 4419443 | 016650 Col. 36 OH | <0.002 |
| 303129 | 4419448 | 016660 Col. 36 KP | 0.07 |
| 303130 | 4410612 | 110466 To TransTx pipe | 1.6 |
| 303130 | 4410612 | treated w 20 ppmEC5492A | 0.79 |
| 303130 | 4410612 | treated w 22 ppm 5407 | 0.73 |
| 303787 | 4428424/432 | PP to TT | 0.004 |
| 303788 | 4427677 | PP to TT | 0.019 |
| 303789 | 4428446/458 | Cavern 6 | 0.3 |
| 303790 | 4427676 | Dryer inlet | 0.12 |
| 303791 | 4428423/421 | Dryer inlet | 4.1 |
| 303792 | 4430113 | PP to TT | 0.64 |
| 303793 | 4430111 | Merox feed | <0.002 |
| 303794 | 4430112 | PB TRTR EFF | 0.002 |
| 303795 | 4434467 | Col 36 OH | <0.002 |

In closing, it should be noted that the discussion of any reference is not an admission that it is prior art to the present invention, especially any reference that may have a publication date after the priority date of this application.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims, while the description, abstract and drawings are not to be used to limit the scope of the invention. The invention is specifically intended to be as broad as the claims below and their equivalents. Each and every claim below is hereby incorporated into the specification as additional embodiments of the present invention.

We claim:

1. A process, comprising:
a) providing a hydrocarbon sample, and subjecting the sample to a liquid chromatographic separation to produce a purified sample;
b) separating the purified sample on a gas chromatography column to produce a separated purified sample;
c) passing the separated purified sample into a mass spectrometer, wherein molecular ions are separated in a first sector, collided with Ar gas in a second sector, and the resulting fragments isolated and detected in a third sector;
d) determining the concentration of elemental sulfur present in the sample of step a) utilizing the data obtained in step c).

2. The process of claim 1, further comprising adding a silylating agent to the purified sample just prior to step b) to improve the accuracy and precision of step d).

3. The process of claim 2, wherein the silylating agent comprises a trimethylsilyl functional group.

4. The process of claim 2, wherein the silylating agent comprises N,O-bis-(trimethylsilyl)-trifluoroacetamide.

5. The process of claim 1, further comprising adding an internal standard to the purified sample just prior to step b), thereby improving the accuracy of the determination of step d).
